(19) United States
(12) Patent Application Publication
(10) Pub. No.: US 2011/0235631 A1
(43) Pub. Date: Sep. 29, 2011

(54) METHOD AND APPARATUS FOR AUTOMATIC VERIFICATION OF TELEPHONE NUMBER MAPPING

(75) Inventors: Venkatesh Krishnaswamy, Holmdel, NJ (US); Eunsoo Shim, Princeton Junction, NJ (US)

(73) Assignee: Avaya Inc., Basking Ridge, NJ (US)

(21) Appl. No.: 12/730,935

(22) Filed: Mar. 24, 2010

(51) Int. Cl. H04L 12/66; G06F 15/16

(52) U.S. Cl. 370/352; 709/245

(57) ABSTRACT

The present disclosure provides mechanisms for verification of mapping from one type of network address to another type of network address based on delivery of a one-time key over one type of the network and confirmation of its receipt over another type of network. A particular example of such mapping is mapping from a telephone number used in the PSTN or the like to a VoIP address such as a SIP URI. The mapping verification mechanisms can be provided without dependence on the records of past calls, manual calling, or the line information database in the PSTN system. Accordingly, a highly secure and efficient mapping verification mechanism is realized.

### FIELD OF THE INVENTION

The invention relates generally to communications and more specifically to mechanisms for verifying address mapping for communications.

### BACKGROUND

The use of telephones for communications purposes is commonplace and often taken for granted. If someone wants to talk to another person on the other side of the country, he or she can pick up a telephone and dial the person's phone number. Presently, in most cases, the ensuing cross-country conversation is carried over the Public Switched Telephone Network (PSTN). The PSTN has been upgraded on a nearly continuous basis as advances in technology have made improvements possible. For example, fiber optic lines have replaced the use of copper lines in many parts of the PSTN. In addition, digital telephone switches have replaced older analog telephone switches.

While significant changes have been made to the PSTN over the years, to the end user, these changes have been relatively transparent. In most cases, end users have been allowed to keep their existing telephone numbers and receive their existing telephone services despite network changes resulting from network upgrades. As known in the art, the PSTN uses a Time Division Multiplexing (TDM) based network.

Telephone service providers are currently confronting the possibility of a transition from the current TDM based network to IP packet based networks which are also capable of carrying voice calls. As technology evolves once again and the prospect of moving from a TDM-based network to a Voice over IP (VoIP) based network becomes more of a reality, several major issues arise.

From a technical standpoint, there is the issue of how to move calls and users from the PSTN to the VoIP network and back, as may be required.

In addition to the issues of physical implementation, there is the practical issue of how to make the transition to a VoIP telephone system as transparent as possible to telephone users. For example, it is highly desirable that phone numbers should not change, and preferably the telephone services that a customer currently receives should continue to function. Maintaining existing phone numbers is particularly important to large companies who want to keep their phone numbers for business purposes. In addition, services such as call forwarding, call waiting, voice mail, etc. are used by many end users, and an interruption in these billable services would be an inconvenience, and may hurt the telephone company from both a customer satisfaction and revenue standpoint. Moreover, a transition from the TDM-based to a VoIP-based network may raise security issues.

During this transition from the TDM-based networks to VoIP-based networks, most VoIP networks are built to interface with the PSTN so that communications are not lost with non-VoIP customers. In particular, as can be seen in FIG. 1, VoIP networks 108a-N within a communication system 100 may be implemented by certain clients in the form of an enterprise network owned and operated by a particular private entity. However, most VoIP networks 108a-N are islands in the PSTN 104. Most Internet Protocol (IP) Private Branch eXchange (PBX) deployments by enterprises usually only totally utilize features of a VoIP network 108 for intra-company communications. Either because some enterprises haven't made the transition to VoIP communications or due to security concerns, most inter-company communications rely on trunk services leveraging the PSTN 104. Thus, even though two different companies have their own IP PBXs, thereby establishing a VoIP network for both, the voice and/or video communications between the different companies still traverse the PSTN 104. Unfortunately, this means that the advanced features offered for IP telephony cannot be utilized for inter-company communications.

FIG. 2A depicts the current way in which inter-company (also referred to as inter-domain) communications are established. In particular, the communication system 200 supports clients that have VoIP networks and clients that still utilize TDM-based networks. In the example depicted in FIG. 2A, Company A utilizes a VoIP network 204, Company B also utilizes a VoIP network 208, and Company C utilizes a TDM-based network 212. Communications between Company A and Company C traverse the PSTN 216 due to the fact that Company C is utilizing a TDM-based network 212. However, communications between Company A and Company B also traverse the PSTN 216, usually because Company A and Company B have not established a trust level for communications over an IP network. In the absence of such trust (i.e., inter-domain federation) the two companies will utilize the more trusted and secure PSTN 216.

### SUMMARY

It would be desirable for the communication system 200 to be configured according to FIG. 2B. In particular, it would be desirable for Company A to communicate with Company B via VoIP network 220. This would allow both companies to reduce overall communication costs by reducing trunk capacity and/or usage charges because most bandwidth utilization over the Internet, for example, is significantly cheaper than bandwidth utilization over the PSTN 216.

The communication system 200 architecture depicted in FIG. 2B would also provide a significant reduction in inter-company video conferencing costs. First of all, the public Internet could be used to carry video packets via the IP PBXs, instead of relying on a third-party video conferencing unit as is the practice of most companies. Moreover, phone-to-phone ad-hoc inter-company video conferencing would become readily available if the companies were communicating with their IP PBXs.

Additionally, the communication system 200 architecture depicted in FIG. 2B would allow companies to utilize advanced IP telephony features for inter-company communications. This would provide a richer more user-friendly communication experience since features like presence, wide-band voice, and the like can be shared across company boundaries and utilized more easily over an IP network as compared to the PSTN 216.

As previously noted, the major hurdle to achieving the architecture depicted in FIG. 2B is the problem of inter-company/inter-domain federation. Inter-company communications requires inter-domain federation and such federation requires that the sending domain determine the address of the receiving domain, usually in the form of a Domain Name Space (DNS) name or one or more IP addresses that can be used to reach the domain. In email and in the web, such address resolution is simple. The identifiers used by those services (i.e., the email address and the web Universal Resource Locator (URL)/Universal Resource Identifier (URI)) embed the address of the receiving domain directly. A simple DNS lookup is all that is required to route the connection.

VoIP protocols, such as the Session Initiation Protocol (SIP), also utilize email address style URIs, to establish calls. However, even when a company internally uses VoIP for intra-company telephony services and all the office phones are VoIP-enabled, the business cards of the employees show typically only telephone numbers but not SIP URIs. That is, only telephone numbers like those specified in E.164 are the only universal addresses for end devices or end users in telephony. This is primarily due to the large installed base of users that continue to exist solely on the PSTN. Additionally, many SIP deployments utilize hardphones or telephony adaptors, and the user interfaces on these devices, which are patterned after existing phones, only allow phone-number based dialing. Thus, these users are only allocated PSTN numbers. Lastly, a large number of SIP deployments are in domains where the endpoints are not IP equipped. Rather, they communicate through a gateway and SIP is only used within the core of the network. Such deployments, similar to others, only use PSTN numbers.

Therefore, to make inter-domain federation incrementally deployable and widely applicable, the federation needs to work with PSTN numbers rather than email address-style SIP URIs. When the human user dials the telephone number of the remote party, the VoIP system should know whether the remote party's device or software has a matching IP-based address (for example, SIP URI) and, if then, internally use the IP-based address to establish a VoIP call to the remote party. Therefore, in particular, there exists a need to reliably, securely, quickly, and repeatedly map PSTN numbers (i.e., phone numbers) to IP-based addresses (i.e., IP addresses, URIs, SIP Address of Record (AOR), etc.). There also exists a need to verify the mapping of PSTN numbers to IP-based addresses and vice-versa.

It is, therefore, one aspect of the present invention to provide a method of verifying a mapping of a second address used by a first entity for communicating over a second network to a first address used by the first entity for communicating over a first network, the method comprising:

transmitting, from a second entity to the first entity, a first payload, wherein the first payload is transmitted via a second network interface at the second entity that is used to establish a connection with the first entity over the second network;

receiving, at the second entity from the first entity, a response payload, wherein the response payload comprises response data and wherein the response payload is received via a first network interface at the second entity that is used to establish a connection with the first entity over the first network;

analyzing, by the second entity, the response data; and

based on the analysis step, the second entity applying the following rule set:
in the event that the response data confirms the first entity received the first payload, confirming that the first entity is entitled to use the first address and the second address; and
in the event that the response data does not confirm the first entity received the first payload, failing to confirm that the first entity is entitled to use at least one of the first address and the second address.

In some embodiments, the first entity (i.e., a first company) asserts proper use of the first address on the first network and proper use of the second address on the second network and the asserted mapping is verified in the event that the response data confirms that the first entity received the first payload.

In some embodiments, the first payload comprises at least one of a password, a session identifier, and the first address, and the first payload is transmitted during a communication session established between the first entity and second entity. Assuming that the first entity receives the first payload, the first entity can generate response that the first entity received the first payload. In such a scenario, the response data may include, but is not limited to, the password, an encrypted value that utilized the password as an encryption key, the session identifier, an encrypted value that utilized the session identifier as an encryption key, the first address, an encrypted value that utilized the first address as an encryption key, and combinations thereof.

In some embodiments, the first address comprises one or more of an IP address, SIP URI, and SIP AOR, and the first network comprises a packet-based communication network, such as the Internet. Additionally, the second address comprises a telephone number and the second network comprises a switch-based communication network, such as the PSTN.

In some embodiments, instructions for performing the above-described methods can be stored in a tangible computer-readable medium. Such instructions can be accessed and implemented by a processor and when the processor implements such instructions, the steps of the methods can be performed.

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module”, “agent”, or “tool” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of embodiments of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram depicting a communication system;

FIG. 2A is a block diagram depicting a communication architecture according to the prior art;

FIG. 2B is a block diagram depicting a communication architecture in accordance with at least some embodiments of the present invention;

FIG. 3 is a block diagram depicting components of a communication system in accordance with at least some embodiments of the present invention; and

FIG. 4 is a flow diagram depicting a message flow for a communication method in accordance with at least some embodiments of the present invention.

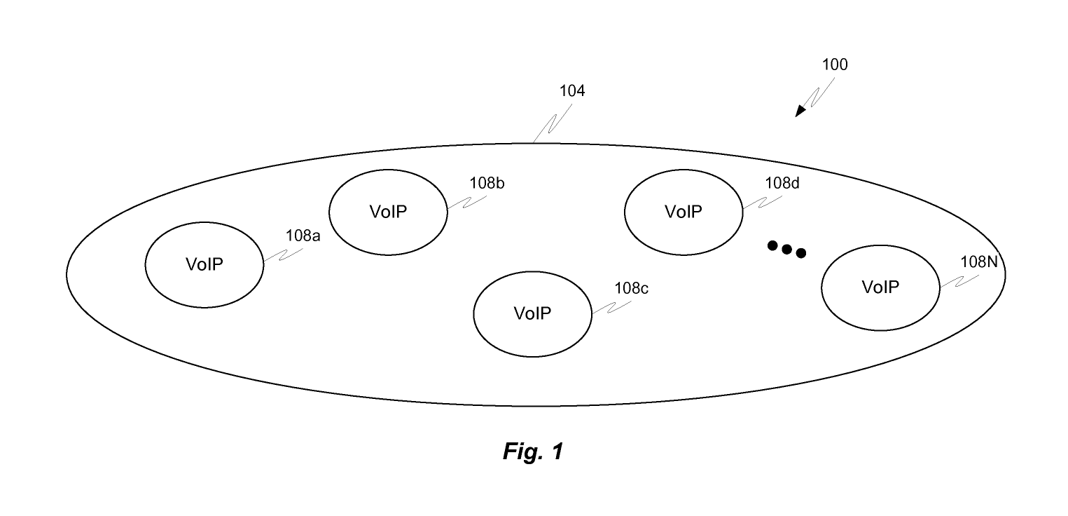

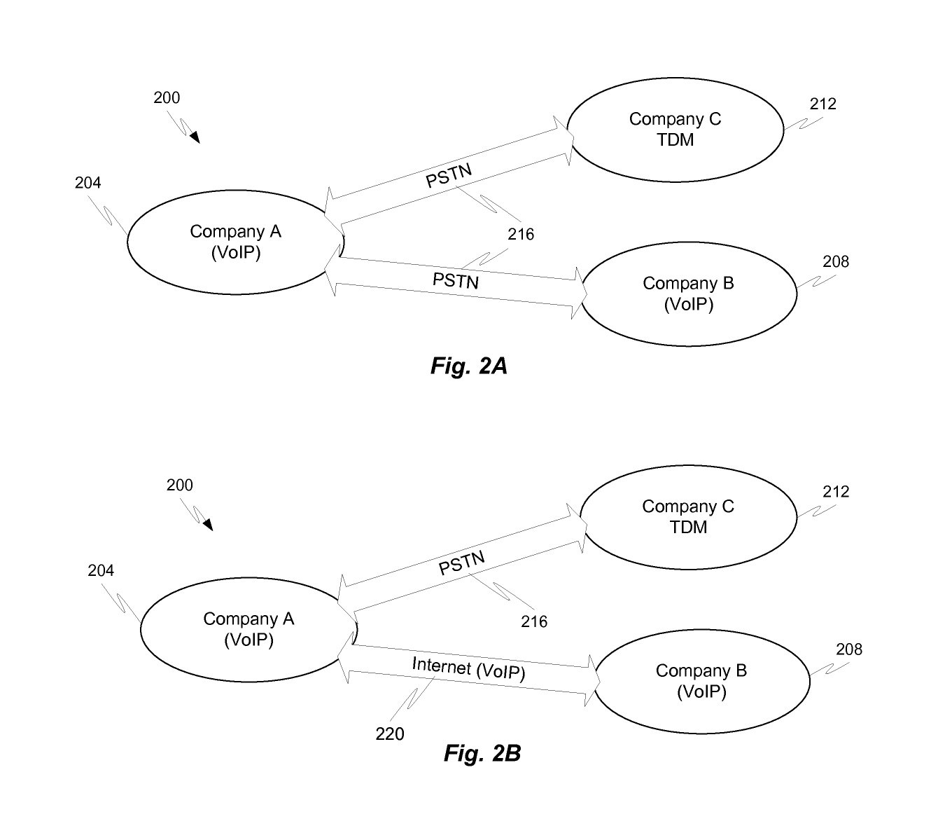

### DETAILED DESCRIPTION

The invention will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any communication application in which it is desirable to provide verify the identity of communicants.

The exemplary systems and methods of this invention will also be described in relation to analysis software, modules, and associated analysis hardware. However, to avoid unnecessarily obscuring the present invention, the following description omits well-known structures, components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

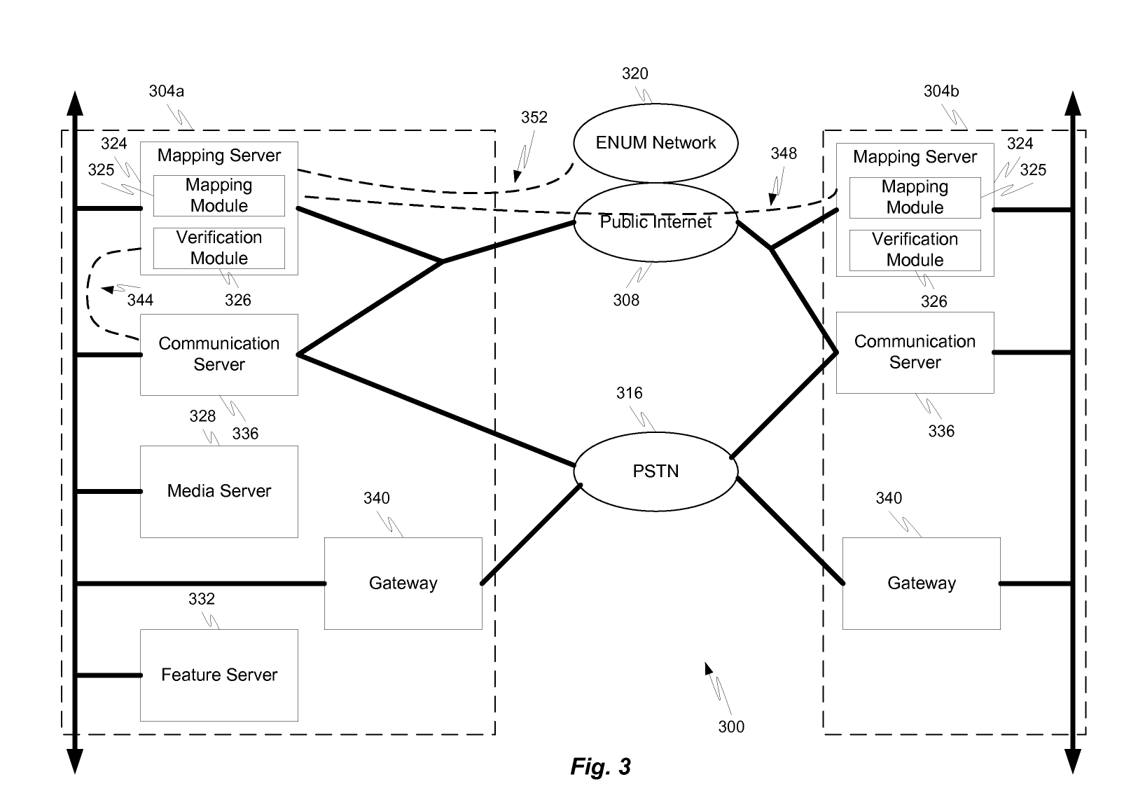

Referring to FIG. 3, an exemplary communication system 300 will be described in accordance with at least some embodiments of the present invention. The communication system 300 may comprise at least a first and second entity 304a, 304b, respectively, that are capable of communicating with one another via a variety of networks. In some embodiments, the media used to exchange communications between the first entity 304a and second entity 304b may vary according to the limitations of the network, user communication devices (i.e., endpoints) used within the entity, intermediate communication components, and the like. Any type of communication medium, such as voice, video, text, and combinations thereof, may be utilized without departing from the scope of the present invention.

In some embodiments, two or more different network types provide communication capabilities between the first entity 304a and second entity 304b. As one example, the first entity 304a and second entity 304b are connected to an IP-based network like the public Internet 308. The IP-based network 308 is the network through which VoIP calls between the first entity 304a and second entity 304b will traverse. The IP-based network 308 may comprise a network operated by a single service provider or a network composed of one or more sub-networks, public or private, operated by one or more service providers. The IP-based network 308 is referred as the Internet for illustration purpose herein. The link from the first entity 304a to the Internet 308 and the link from the second entity 304b to the Internet 308 may be of a variety of types. The link may be over a DSL line, a cable network, an optic-fiber network, a T1/T3 line, etc., provided by the same service provider or different service providers.

The first entity 304a and second entity 304b are also connected to a circuit-switched network, such as the PSTN 316. The PSTN 316 uses telephone numbers as the addresses of the end devices such as desktop phones, cordless phones, and cell phones. The PSTN 316 is not a single homogenous network in most environments. Internally, portions of the PSTN 316 may be implemented over fiber optic trunks, copper cables, microwaves, etc. Some portions of the PSTN 316 may operate as a packet-switched network and other portions may operate as a circuit-switched network. Cellular networks such as Global System for Mobile (GSM) may be included in the PSTN 316. Some portions of the PSTN 316 may be implemented with VoIP trunks. The internal composition and operations of the PSTN 316 is typically transparent to the end users.

The first entity 304a and second entity 304b may have one or more links to the PSTN, some may be VoIP trunks and others be TDM trunks. In an example, the gateway 340 handles the TDM link to the PSTN 316 and the communication server 336 handles the VoIP link to the PSTN 316. One gateway 340 may handle one or more TDM links and a single communication server 336 may handle one or more VoIP trunks. The links to the PSTN 316 may connect to the same service provider or different providers. In some embodiments, the functionality of the communication server 336 and the gateway 340 may be combined in a single device, thereby providing a single point source for handling the VoIP trunks and the TDM trunks.

Regardless of the type of the link to the PSTN 316, the first entity 304a and second entity 304b are assigned one or more telephone numbers or portions of it (e.g., extensions) from the service provider.

In some embodiments, the mapping server 324 participates in an overlay network 320 as a peer, thereby allowing the mapping server 324 to publish data about telephone numbers used by a particular entity and query the overlay network 320 to get telephone number data.

The overlay network 320 is a virtual network over the Internet, comprised by the mapping servers 324 from one or more organizations/entities. The overlay network 320 may contain different types of network nodes playing different roles. The overlay network 320 implements a kind of distributed database, providing storage for mapping server records that are put therein by the mapping servers. The mapping server records contain the telephone number and the contact address of the mapping server 324 that asserts ownership or access rights to the telephone number. The overlay network 320 also supports query and retrieval of the mapping server records.

In a different embodiment of the present invention, a central server or a cloud of servers may substitute the overlay network 320.

FIG. 3 also shows the various types of communication components which may be associated with (e.g., owned/leased and operated/administered by) an entity 304a, 304b. In some embodiments, the entities 304a, 304b comprise a mapping server 324, media server 328, a feature server 332, a communications server 336, and a gateway 340.

The mapping server 324 may include a discovery module 325 and a verification module 326. The discovery module 325 is used by the mapping server 324 to communicate with the overlay network 320 and discovers the IP address of the mapping server serving the remote party's telephone number. As an example, if a particular communication device of the first entity 304a has been assigned a first telephone number and the mapping server 324 is assigned a first IP address, then the discovery module 325 will assert a mapping between the first telephone number and the first IP address or the contact address of the mapping server 324 to the overlay network 320. The asserted address mappings may be maintained by the overlay network 320 in a form of distributed database for future reference.

The mapping discovery module 326 of the mapping server 324 is used to retrieve asserted address mappings from the overlay network 320 and the verification module 326 is used to verify such mappings with the entity that has asserted the address mapping. In some embodiments, a verification protocol 348 is implemented by the mapping verification module 326 whereby the mapping verification module 326 communicates with the mapping server 324 of another entity in an attempt to verify that the other entity actually owns or has rights to use both addresses (i.e., the telephone number and IP address) that have been asserted at the overlay network 320.

The communication server 336 may include any type of server or collection of servers that enable communication services. In some embodiments, the communication server 336 may include an IP PBX, such as Avaya Aura Session Manager or Communication Manager running on a server, such as Avaya S8510 Server. In some embodiments, the communication server 336 facilitates communications over the packet-switched networks 308 by providing encoding/decoding services, call routing services, and the like. In some embodiments, the communication server 336 represents a communication interface which allows an entity to establish a connection with another entity via a packet-switched network 308. As noted above, the communication server 336 may also support VoIP trunks as connections to the PSTN 316 which means that the communication server 336 may also represent a communication interface which allows an entity to establish a connection with another entity via PSTN 316.

The gateway 340 may comprise any type of translation device or service that converts digital media streams between disparate telecommunications networks. The gateway 340, in some embodiments, may connect different types of networks (i.e., the PSTN 316 with the packet-switched infrastructure of the entity) by providing functions for converting between different transmission and coding techniques. In particular, the gateway 340 may perform a conversion between TDM-based messages and a media streaming protocol (usually Real-time Transport Protocol (RTP)) or a signaling protocol used in the VoIP system of the entity. In some embodiments, the gateway 340 represents a communication interface which allows an entity to establish a connection with another entity via the PSTN 316.

The media server 328 may be responsible for processing the audio and/or video streams associated with telephone calls, connections, or communication sessions, regardless of whether or not the calls, connections, or sessions are intra-company or inter-company. A voicemail server is an example of the media server 328. In some embodiments, the communication server 336 may include logic for controlling the media server 328 and functions thereof. As one example, the communication server 336 may utilize SIP to control the operations of the media server 328 during real-time and non-real-time communications.

The feature server 332 may provide additional communication features for communication sessions within the first entity 304a or between users of the first entity 304a and users of the second entity 304b. In particular, features provided by the feature server 332 may be made available for communication sessions between the first entity 304a and second entity 304b because the communication session is traversing a packet-switched network 308, 312 that enables such features as opposed to traversing the PSTN 316, which has traditionally restricted such features. Exemplary features which may be provided by the feature server 332 include, without limitation, conferencing features, presence features, wide-band audio features, video features, recording features, caller identification features, line appearance features, advanced contact resolution features (e.g., call forwarding and/or twinning rules), coverage features (e.g., call blocking, secretarial coverage, etc.), and so on. The features provided by the feature server 332 may be invoked by the communication server 336, based on a participant's or enterprise's communication preferences. In other words, the communication server 336 may include communication preferences for all users in the first entity 304a and may invoke certain features, perhaps via application sequencing, of the feature server 332 based on such preferences.

Although the various components depicted in FIG. 3 are depicted as separate and distinct components, one skilled in the art will appreciate that the components may be logically and/or physically separate or logically and/or physically combined. In particular, the communication components of a particular entity may be provided as logically separate software routines or modules stored on a common server. Alternatively, or in addition, some of the components may be provided as physically separate components on physically separate servers. In other embodiments, one or more of the communication components may be provided on multiple servers, either in a server-farm configuration, or in a cloud-computing configuration.

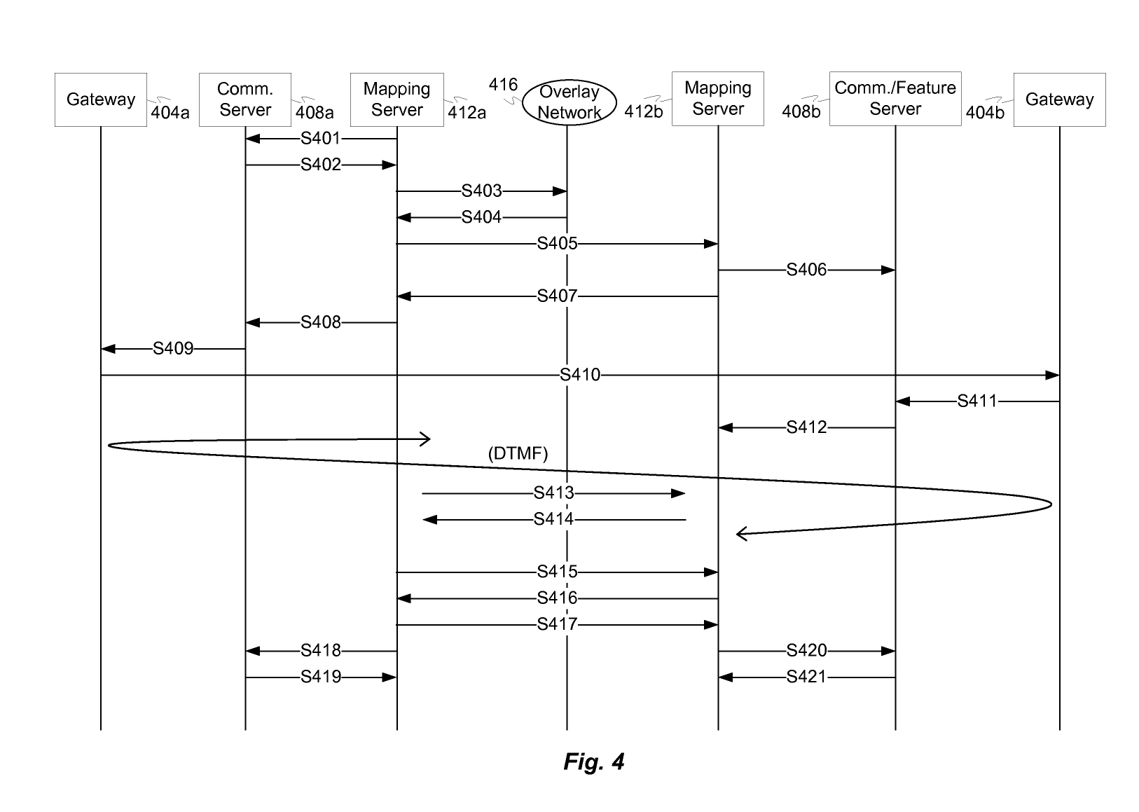

With reference now to FIG. 4, an exemplary address mapping verification method will be described in accordance with at least some embodiments of the present invention. The method is initiated when a first mapping server 412a associated with a first entity 304a requests call records of recent calls between the first entity 304a and a second entity 304b (S401). The request may also include a request for a copy of the routing table used by the communication server 408a during such calls. The request is transmitted to a first communication server 408a associated with the first entity 304a.

The first communication server 408a responds to the request by providing the requested call records and/or routing table back to the first mapping server 412a (S402). The first mapping server 412a then analyzes the call records and routing table and selects one or more telephone numbers whose IP address, SIP URI, etc. are to be discovered/verified.

In a different embodiment, the communication server 408 detects a telephone number for which matching IP-based addresses is not known and sends a request to the mapping server 412a to discover matching IP-based addresses.

Based on this analysis, the first mapping server 412a generates and transmits a lookup request to the overlay network 416, which may be similar or identical to the overlay network 320 (S403). The lookup request may include a telephone number that was identified in S402 or a lookup key derived from the telephone number and other elements such as the data type name. The overlay network 416 analyzes the request, searches its mapping database(s) and retrieves any data matching the lookup key. Such data is called a mapping server record herein. These search and retrieval steps may be performed one or more times, once for each telephone number, or once for multiple telephone numbers.

Results of the lookup are then provided back to the first mapping server (S404). If there is no mapping server record for the telephone number, then the first mapping server 412a marks the telephone number as NO MAPPING RECORD in an internally maintained verification database. If, however, a mapping server record does exist, then the first mapping server 412a updates its internally maintained verification database to reflect an asserted address mapping, perhaps by identifying the address of the mapping server that has been mapped to the telephone number in the overlay network 416.

Thereafter, the first mapping server 412a begins the process of verifying the asserted mapping with a second entity 304b that supposedly asserted the mapping between the telephone number and its own IP address or another form of its own address such as a DNS hostname. In particular, the first mapping server 412a (“Verifier”) of the first entity 304a establishes a secure connection, such as a secure Transport Control Protocol (TCP) connection, with the second mapping server 412b (“Verified”) of the second entity 304b (S405) over the IP-based network such as the Internet. This may be accomplished in a number of ways. For example, one method of establishing a secure connection between the Verifier and Verified is to have a Transport Layer Security (TLS) certificate of the Verified included in the mapping server record of the Verified 412b. The Verifier 412a can then use the certificate for encryption of communications with the Verified 412b. The use of TLS certificates is well known in the communication arts for establishing secure connections between entities.

The Verifier 412a establishes a verification session with the Verified 412b and a Verification Session Identifier (SID) is generated and shared between the Verifier 412a and the Verified 412b. The SID may include a hash value calculated based on one or more of the Verifier's IP-based address, the Verified's IP-based address, the target telephone number, etc. The Verifier 412a notifies the Verified 412b of the target telephone number whose mapping server record to be verified. If the Verified 412b does not recognize the telephone number as a number used in its telephony system or it asserted mapping from the telephone number to its IP-based address, the Verified 412b terminates the session. The Verified 412b and the Verifier 412a internally store information about the session including the SID, the IP-based addresses of the other party (the Verifier or the Verified), the target telephone number for future reference.

Thereafter, the Verified is allowed to select the time, or window of time, during which a verification call will take place. The selected time may be immediate or some time in the future. If the Verified elects to accept the verification call immediately, it arranges a way to receive the verification call. One way of such is setting up call forwarding for the target phone number (i.e., the phone number currently having its mapping verified) with the communication server/feature server 408b of the second entity 304b (S406). If the verification call does not occur immediately, then this step can be delayed until either the Verifier sends a second initiation request or the predetermined time occurs. The purpose of call forwarding is to have the verification call forwarded to the Verified 412b. In some embodiments, it will be advantageous to immediately terminate the call forwarding setup after the verification call. How the call forwarding is setup depends on the architecture of the VoIP network of each organization and the supported interfaces of the communication components.

After setting up call forwarding, the Verified notifies the Verifier to place the verification call immediately (S407). Also during this step, if the Verified chooses to handle verification later, it may specify the future time, or time window, in its response to the Verifier. The response from the Verified may also contain a predetermined Dual-Tone Multi-Frequency (DTMF) sequence for the Verifier to follow before the Verifier sends payload digits to the Verified. This DTMF sequence may be referred to as a preamble sequence of digits and could be the extension number for the second mapping server 412b. Alternatively, the DTMF sequence may be null, in which case the Verifier may send the payload digits immediately after the call is established, without any preamble DTMF sequence.

If the response from the Verified specifies a future time for verification call, the Verifier repeats the process from S405 at the specified future time or after it.

Thereafter, the Verifier initiates the verification call by invoking the first communication server 408a to route a call to the Verified through the first gateway 404a and via the PSTN 316 (S408, S409, and S410).

Upon receipt of the call at the Verified's domain 304b, the second gateway 404b in the Verified domain relays the call to the second call router 408b (S411). The second call router 408b then forwards the call to the Verified 412b with help from the feature server (S412). The manner in which the call is forwarded to the Verified 412b may vary depending upon the architecture of the Verified's domain. As one example, the call may be forwarded to the Verified only after the preamble DTMF sequence is sent to the Verified by the Verifier. This may involve the use of an Interactive Voice Response (IVR) unit at the Verified's domain which is capable of determining that a preamble DTMF sequence has been received, and in response to making such a determination, automatically forwarding the call to the Verified 412b such that the subsequent payload transmitted by the Verifier is sent directly to the Verified 412b.

Once the Verifier and Verified have established a connection over the PSTN 312, the Verifier sends payload digits to the Verified, usually in the form of DTMF signals or sequences (S413). The first payload may include one or more of a password (e.g., a one-time random key of DTMF digits), the SID sent in S405, and the telephone number being verified. Each field may be delimited from one another via the predetermined delimiter DTMF sequence.

In some embodiments, the Verified checks the received SID and if the SID is either incorrect or not recognized, then the Verified sends an error message to the Verifier.

Thereafter, the Verified acknowledges receipt of the first payload (S414). Following receipt of the response payload, the Verifier terminates the communication session that was established over the PSTN 312.

At some point thereafter, the Verifier sends a challenge to the Verified over an IP connection (i.e., through the Internet or a private packet-switched network 308) (S415). In other words, the Verifier sends a challenge to a non-telephone number that has been mapped to the telephone number in the overlay network 416. The challenge may include a request for information verifying that the Verified actually was the party involved in the previous communication session over the PSTN 312 and further verifying that the Verified recognized the payload digits.

The challenge message from the Verifier S415 includes also the IP-based addresses to be used by the communication devices in the Verifier's domain such as the communication server 408a as the source address in the future VoIP sessions toward the target telephone number. The IP-based addresses may be SIP URIs, a domain name, host names of the same domain, etc.

In response to receiving the challenge, the Verified generates and transmits a response payload comprising response data to the Verifier (S416). In particular, the response data provides that the Verified knows the data that was included in the first payload. The response data also proves that the Verified owns and represents the telephone number used to establish the previous communication session over the PSTN 316. The response data, in some embodiments, may indicate that the Verified received and recognized the payload sent by the Verifier in S415 and may include one or more of the password, an encrypted value that utilized the password as an encryption key, the SID, an encrypted value that utilized the SID as an encryption key, the telephone number, an encrypted value that utilized the telephone number as an encryption key, and combinations thereof.

There are many known methods to authenticate a remote party over a data connection based on a shared secret (the password sent over the PSTN connection S413 in this case). There are a number of protocols published by the IETF or used in the industry for the purpose. Any of the protocol or variations of such a protocol may be used in this step.

The response message from the Verified S416 includes also the IP-based address that may be used to establish a VoIP session toward the target telephone number. The IP-based address may be a SIP URI, a SIP AOR, or any form of IP-based address that VoIP protocols use. A communication device in the Verifier's domain, for example, the communication server (336, 408a) will translate the target telephone number to this IP-based address when a telephone call is initiated by a user device in the Verifier's domain to the target telephone number.

The response message from the Verified S416 may also include an authentication key that will be used in the future VoIP sessions from the Verifier's domain to the target telephone number. The authentication key allows the communication device in the Verified's domain, for example, the communication server 408b to authenticate the communication devices in the Verifier's domain such as the communication server 408a in the future VoIP calls over the IP-based network 308.

Thereafter, the Verifier terminates the IP connection (S417). Upon receipt of the response data, the mapping verification module 326 analyzes the response data and applies the following rule set:
in the event that the response data confirms the Verified received the first payload, confirming that the Verified is entitled to use the target telephone number; and
in the event that the response data does not confirm the Verified received the first payload, failing to confirm that the Verified is entitled to use the target telephone number and the IP address.

Following termination of the IP connection, the Verifier 412a sends the discovered phone number mapping data (including phone number, IP address, SIP URI, and/or authentication key) to the first communication server 408a (S418). The first communication server 408a then acknowledges receipt of mapping data (S419).

Concurrently or thereafter, the Verified 412b sends the information about the Verifier's domain such as the domain name and the authentication key to the communication server 408b or other communication devices in its domain (S420). A confirmation of receipt may then be sent back to the Verified 412b (S421).

When the first communication server 408a tries to establishes a VoIP session destined to the SIP URI matching the target telephone number, the second communication server 408b will authenticate the first communication server 408a using the above authentication key. Authentication of the calling party enables the second communication server 408b to permit incoming VoIP sessions only from the domains that went through the above-described phone number mapping verification process.

To make a VoIP call to the Verified's domain, potential spammers and other unscrupulous parties must have made the verification call over the PSTN. This discourages the potential spammers because a PSTN call is not free in most environments and furthermore a PSTN call makes it easy to trace back to the caller, which means the spammer takes the risk of receiving legal penalties for unlawful spam calls. The authentication key can also be used to generate encryption keys to encrypt the packets of the future VoIP calls from the Verifier's domain to the Verified's domain or generate new authentication keys.

Transmitting information about the contact addresses of the Verifier and the Verified in the connection over the PSTN in the form of SID or other steps similar to S413 is particularly useful to defend against Man-In-The-Middle attacks in that the first payload, possibly comprising a SID value, to the Verified over a relatively secure network (i.e., the PSTN 312). If a Man-In-The-Middle attack is attempted, the attacker asserts mapping of the telephone number to the attacker's contact address. Then the Verifier will generate the SID using the attacker's contact address and sends it to the genuine owner of the phone number over the PSTN connection, which will be rejected by the genuine owner of the phone number.

It should be noted that the gateways 404a, 404b may be implemented as a PSTN gateway or media gateway that is capable of DTMF signal extraction/translation. When a gateway 404a, 404b is equipped for DTMF signal extraction/translation, the DTMF signals may be carried between mapping servers 412a, 412b and gateways 404b, 404a, using one or more of RTP Named Telephone Event (NTE), which is described in RFC 2833, SIP INFO, and SIP NOTIFY method. Otherwise, the DTMF signal is carried as RTP stream and the mapping server 412a and 412b extract it.

Additionally, the mapping server of the Verified should be able to setup and release call forwarding with relative ease. Typically, dynamic call forwarding is performed by a feature server 332, making real-time call forwarding setup feasible. The component that is used to provide call forwarding setup services and the method of interaction used between the mapping server and other components is architecture/implementation specific. For a publicly attended phone number (e.g., 8xx number), dynamic call forwarding may not be necessary. A static extension allocation for the mapping server may be sufficient.

In the interaction between the mapping server and the communication server, the call router may be adapted to pick the peer for an outbound call. Moreover, destination phone numbers to peer mappings may constitute the call routing table. In the scenario discussed above, the mapping server is capable of pulling the call routing table from the call router and identifying the target phone number to find the corresponding SIP peers from the call records. This is generally referred to as a pull model. In some embodiments, the communication server may be adapted to push the target phone numbers to the mapping server.

Additionally, in the scenario described above, the mapping server pushed the discovered SIP peer information to the call router. This is generally referred to as a push model. In some embodiments, the communication server may be adapted to pull the SIP peer information from the mapping server without departing from the scope of the present invention. The decision to use a push or pull model for either of the mapping server/call router interactions may vary depending upon the specific architecture desired and other user preferences.

While the above-described figures have been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The messages may contain implementation specific elements. The composition of each message may be altered in various ways without departing from the present invention. Some messages may be split into two or more messages or some messages may be combined without departing from the present invention.

In the above embodiment scenario, the first entity 304a and second entity 304b are described to implement the telephone number mapping for their own communication use. In some embodiments, the first entity 304a may be a mapping service provider and the second entity 304b may be a mapping service user or subscriber. In that scenario, the overlay network is likely to be replaced by a central server operated by the first entity 304a. The mapping server of the second entity asserts the mapping of a telephone number to its contact address to the central server. Then the first entity 304a initiates the verification procedure almost identical to what is described in the above. Other entities that look for the SIP URI or similar VoIP address corresponding to a telephone number of the second entity 304b connect to the central server operated by the first entity 304a and retrieve the information. The first entity 304a is a trusted entity by the other entities and thus the mapping information provided by the first entity 304a is trusted in this scenario.

The systems, methods and protocols of this invention can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a server, personal computer, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the communication and computer arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with embodiments of the present invention, systems, apparatuses and methods for mapping numbers, such as IP addresses and phone numbers, between different networks and verifying the accuracy of such mappings. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method of verifying a mapping of a second address used by a first entity for communicating over a second network to a first address used by the first entity for communicating over a first network, the method comprising:
transmitting, from a second entity to the first entity, a first payload, wherein the first payload is transmitted via a second network interface at the second entity that is used to establish a connection with the first entity over the second network;
receiving, at the second entity from the first entity, a response payload, wherein the response payload comprises response data and wherein the response payload is received via a first network interface at the second entity that is used to establish a connection with the first entity over the first network;
analyzing, by the second entity, the response data; and
based on the analysis step, the second entity applying the following rule set:
in the event that the response data confirms the first entity received the first payload, confirming that the first entity is entitled to use the first address and the second address; and
in the event that the response data does not confirm the first entity received the first payload, failing to confirm that the first entity is entitled to use at least one of the first address and the second address.

2. The method of claim 1, wherein the first entity asserts proper use of the first address on the first network and proper use of the second address on the second network and wherein the asserted mapping is verified in the event that the response data confirms that the first entity received the first payload.

3. The method of claim 1, wherein the first payload comprises at least one of a password, a session identifier, and the first address, wherein the first payload is transmitted during a communication session established between the first entity and second entity, and wherein the response data confirms that the first entity received the first payload when the response data includes at least one of the password, an encrypted value that utilized the password as an encryption key, the session identifier, an encrypted value that utilized the session identifier as an encryption key, the first address, and an encrypted value that utilized the first address as an encryption key.

4. The method of claim 1, wherein the transmitting step is performed at a time or within a window of time specified by the first entity.

5. The method of claim 1, wherein the first address comprises one or more of an IP address, SIP URI, and SIP AOR, wherein the first network comprises a packet-based communication network, wherein the second address comprises a telephone number, and wherein the second network comprises one or more of a telephony service network and the PSTN.

6. The method of claim 1, wherein the transmitting, receiving, and analyzing steps are performed during a real-time communication session established between the first and second entities.

7. The method of claim 1, wherein the first payload is transmitted in more than one message transmitted from the second entity to the first entity.

8. The method of claim 1, wherein the first payload comprises a string of DTMF signals followed by a shared secret, wherein the string of DTMF signals indicates to the first entity that the shared secret is going to be transmitted in the first payload.

9. The method of claim 8, wherein the response data confirms that the first entity received the first payload when the response data includes at least one of the shared secret and a value composed based on the shared secret.

10. A communication system configured to verify a mapping of a second address used by a first entity for communicating over a second network to a first address used by the first entity for communicating over a first network, the system comprising:
a mapping server owned and operated by a second entity, the mapping server comprising a mapping verification module, the mapping verification module configured to cause a first payload to be transmitted to the first entity via a second network interface that is used by the second entity to establish a connection with the first entity over the second network, the mapping server further configured to analyze response data within a response payload received from the first entity, wherein the response payload is received at the second entity via a first network interface that is used by the second entity to establish a connection with the first entity over the first network, and wherein the mapping verification module is further configured to apply the following rule set based on the analysis of the response data:
in the event that the response data confirms the first entity received the first payload, confirming that the first entity is entitled to use the first address and the second address; and
in the event that the response data does not confirm the first entity received the first payload, failing to confirm that the first entity is entitled to use at least one of the first address and the second address.

11. The system of claim 10, wherein the first entity asserts proper use of the first address on the first network and proper use of the second address on the second network and wherein the asserted mapping is verified in the event that the response data confirms that the first entity received the first payload.

12. The system of claim 10, wherein the first payload comprises at least one of a password, a session identifier, and the first address, wherein the first payload is transmitted during a communication session established between the first entity and second entity, and wherein the response data confirms that the first entity received the first payload when the response data includes at least one of the password, an encrypted value that utilized the password as an encryption key, the session identifier, an encrypted value that utilized the session identifier as an encryption key, the first address, and an encrypted value that utilized the first address as an encryption key.

13. The system of claim 10, wherein the first entity specifies a time or window of time within which the second entity is allowed to transmit the first payload and wherein the second entity causes the first payload to be transmitted within the specified time or window of time.

14. The system of claim 10, wherein the first address comprises one or more of an IP address, SIP URI, and SIP AOR, wherein the first network comprises a packet-based communication network, wherein the second address comprises a telephone number, and wherein the second network comprises one or more of a telephony service network and the PSTN.

15. The system of claim 10, wherein the mapping verification module causes the first payload to be transmitted during a real-time communication session established between the first and second entities.

16. The system of claim 10, wherein the first payload is transmitted in more than one message transmitted from the second entity to the first entity.

17. The system of claim 10, wherein the first payload comprises a string of DTMF signals followed by a shared secret, wherein the string of DTMF signals indicates to the first entity that the shared secret is going to be transmitted in the first payload.

18. The system of claim 17, wherein the response data confirms that the first entity received the first payload when the response data includes at least one of the shared secret and a value composed based on the shared secret.

19. A computer program product comprising computer executable instructions stored onto a tangible computer readable medium which, when executed by a processor of a computer, cause the processor to execute a method of verifying a mapping of a second address used by a first entity for communicating over a second network to a first address used by the first entity for communicating over a first network, the method comprising:
causing a first payload to be transmitted from a second entity to the first entity, wherein the first payload is transmitted via a second network interface at the second entity that is used to establish a connection with the first entity over the second network;
receiving, at the second entity from the first entity, a response payload, wherein the response payload comprises response data and wherein the response payload is received via a first network interface at the second entity that is used to establish a connection with the first entity over the first network;
analyzing, by the second entity, the response data; and
based on the analysis step, the second entity applying the following rule set:
in the event that the response data confirms the first entity received the first payload, confirming that the first entity is entitled to use the first address and the second address; and
in the event that the response data does not confirm the first entity received the first payload, failing to confirm that the first entity is entitled to use at least one of the first address and the second address.

20. A method, comprising:
receiving, at a first entity, a first payload transmitted from a second entity, wherein the first payload is received via a second network interface at the first entity that is used to establish a connection with the second entity over one or more of a telephony service network and the PSTN;
generating a response payload based on the first payload, wherein the response payload comprises response data verifying that the first entity received the first payload, wherein the first payload comprises a shared secret, and wherein the response data includes at least one of the shared secret and a value composed based on the shared secret; and
transmitting the response payload from the first entity to the second entity, wherein the response payload is transmitted via a first network interface at the first entity that is used to establish a connection with the second entity over a packet-based network.
